(19) United States
(12) Patent Application Publication
(10) Pub. No.: US 2007/0154004 A1
(43) Pub. Date: Jul. 5, 2007

(54) Sender disablement of simultaneous rings and routed rings

(76) Inventor: Brain K. Daigle, Marietta, GA (US)

Correspondence Address: SCOTT P. ZIMMERMAN, PLLC, PO BOX 3822, CARY, NC, 27519, US

(21) Appl. No.: 11/321,619

(22) Filed: Dec. 29, 2005

(51) Int. Cl. H04M 3/42

(52) U.S. Cl. 379/211.04

(57) ABSTRACT

Simultaneous ring control services provide control features for a calling party or a called party to override a simultaneous ring service to multiple associated communications addresses. According to some exemplary embodiments, the calling party can control routing of his/her outgoing communication signal to a selected communications address(es) associated with the simultaneous ring service and disable routing of his/her outgoing communication signal to other communications address of the simultaneous ring service. According to other exemplary embodiments, the called party may control an alternate message or alert to the disabled communications addresses such that the disabled communications address(es) receive a shared notification of the outgoing communication from the calling party and information of the communications connection among the calling party's communications device and the selected communications device of the called party.

### CROSS REFERENCE TO RELATED APPLICATIONS

Additionally, this application relates to a commonly assigned co-pending application entitled “Disablement of Simultaneous Ringback” (Attorney Docket BS050302) filed simultaneously herewith, and of which is incorporated herein by this reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

This application generally relates to field of communications. More particularly, this invention relates to a system and method for called party identification of a communications address that answers an incoming communication to a simultaneous ring service.

Telecommunications has experienced explosive growth, and more growth is planned as telecommunication access and numerous communications devices improve. This explosive growth is revolutionizing special services offered to subscribing customers. Of the special service offerings, the simultaneous ring service is relevant to this discussion. Today, more and more individuals (also referred to herein as “subscribers,” “users,” and “customers”) have different telephone numbers, such as, for example, different telephone numbers for his/her home, his/her office, his/her cellular phone, and his/her pager. A calling party is often required to dial or otherwise initiate multiple communications in order to reach the individual—that is, the calling party calls a first telephone number and waits to see if the individual answers the call. If the call is not answered, then the calling party calls a second telephone number and again waits to see if the individual answers the call. This continues with a third telephone number, a fourth telephone number, and so on until the call attempt is answered or until the calling party gives up trying to contact the called party. Consequently, this process is often frustrating for the calling party because the calling party must initiate a series of different calls to different telephone numbers before reaching the calling party. And, called parties may also be frustrated because despite the efforts of the calling party to contact the individual, the end result may still be a missed call.

Conventional simultaneous ring services provide a ringing tone on a dialed telephone number of the incoming call and on selected secondary telephone numbers. Such a service connects the calling party to a telephone that is answered first. As known by those of ordinary skill in the art, these simultaneous ring services may be extended to ring many different telephone numbers at the same time or alternatively, to ring a series of telephone numbers in rapid succession. Although such simultaneous ring services have provided some convenience in reaching the called party, there are problems with implementation, with integration with other service offerings, and with communications to evolving communications systems.

### SUMMARY

The aforementioned problems, and other problems, are reduced, according to exemplary embodiments, by methods, systems, and devices that provide control features for simultaneous ring services. In some of the exemplary embodiments, a calling party uses a communications device that includes a computer program product—a Simultaneous Ring Control Module—that overrides a simultaneous ring service to multiple associated communications addresses. That is, the calling party can control routing of his/her outgoing communication signal to a selected communications address(es) associated with the simultaneous ring service and disable routing of his/her outgoing communication signal to other communications address of the simultaneous ring service. For example, the calling party may wish to only contact a called party at a residential telephone number and not to disturb them at other communications addresses like an office telephone number, a cellular telephone number, and others. If the calling party knows that the called party subscribes to a simultaneous ring service that simultaneously tries to establish a communications connection with the first answering communications address of multiple communications address, then the calling party may control routing of his/her outgoing communication such that only the residential telephone number receives the communications signal and such that simultaneous ring services for other communications addresses (e.g., cellular phone, work phone, home computer, and others) are disabled. In further exemplary embodiments, a communications device of the called party having the Simultaneous Ring Control Module may further enable the called party to control an alternate message or alert to the disabled communications addresses such that the disabled communications address(es) receives a shared notification of the outgoing communication from the calling party and information of the communications connection among the calling party's communications device and the selected communications device of the called party. Alternatively, the calling party may use a conventional telephone to access a communications network having a server-component Simultaneous Ring Control Module, activate control features for communicating with one or more selected communications addresses of a simultaneous ring service, provide communications instructions each selected communications address, and communicate the communications signal to the selected communications address(es). The communications signal may include text, video, voice, and/or digital data. After the communications signal is communicated to the selected called party's communications address(es), a connected communications device of the called party, or alternative a computer product of the communications network, may act on this information. For example, the called party may review the incoming communications signal to determine that simultaneous ring was disabled for other associated simultaneous ring communications addresses, generate a shared notification message to other associated simultaneous ring communications address, store the selection instructions from the calling party, and/or other handling options. Additionally, a telecommunications customer may subscribe to a blocking service to decline or otherwise prevent a calling party from controlling his/her simultaneous ring services to his/her selected communications addresses.

The exemplary embodiments also include a computer program product for Simultaneous Ring Control services. The computer program product comprises a computer-readable medium and a Simultaneous Ring Control Module stored on the computer-readable medium. The Simultaneous Ring Control Module includes computer code that accesses, requests, and/or generates the actual communications address or other identifier of the called party answering an incoming communication to a simultaneous ring line (e.g., a communications address subscribing to the simultaneous ring service). The Simultaneous Ring Control Module routes or otherwise initiates communication of a communications signal from a calling party to only a selected communications address(es) of a simultaneous ring service. That is, if the calling party does not select a communications address(es) or if the calling party only identifies a selected communications address(es) of a simultaneous ring service, then simultaneous ring service is disabled for these non-selected communications addresses.

Other systems, methods, and/or computer program products according to the exemplary embodiments will be or become apparent to one with skill in the art upon review of the following drawings and detailed description. It is intended that all such additional systems, methods, and/or computer program products be included within and protected by this description and be within the scope of this invention.

### DESCRIPTION OF THE DRAWINGS

These and other features, aspects, and advantages of the exemplary embodiments are better understood when the following description is read with reference to the accompanying drawings, wherein:

FIG. 1 is a simplified schematic of a Simultaneous Ring communications system as known in the prior art;

FIG. 2 is a detailed schematic of a Simultaneous Ring communications system similar to that shown in FIG. 1;

FIG. 3 is a simplified schematic of a Simultaneous Ring Control communications system according to some of the exemplary embodiments;

FIG. 4 is a detailed schematic of the Simultaneous Ring communications system of FIG. 3;

FIG. 5 is another schematic of a Simultaneous Ring Control communications system according to some of the exemplary embodiments;

FIG. 6 is a block diagram of a communications device having a Simultaneous Ring Control Module according to some of the exemplary embodiments;

FIG. 7 is a further schematic of a Simultaneous Ring Control communications system according to some of the exemplary embodiments;

FIG. 8 is a more detailed schematic of the Simultaneous Ring Control communications system of FIG. 7;

FIG. 9 is a perspective view of a Caller Identification display of a disabled simultaneous ring communications device according to some of the exemplary embodiments; and

FIG. 10 is another schematic of a Simultaneous Ring Control communications system according to some of the exemplary embodiments.

### DESCRIPTION

The exemplary embodiments now will be described more fully hereinafter with reference to the accompanying drawings. The reader should recognize, however, that the exemplary embodiments may be embodied in many different forms and should not be construed as limited to the embodiments set forth herein. These embodiments are provided so that this disclosure will be thorough and complete and will fully convey the scope of the exemplary embodiments. Moreover, all statements herein reciting exemplary embodiments, as well as specific examples thereof, are intended to encompass both structural and functional equivalents thereof. Additionally, it is intended that such equivalents include both currently known equivalents as well as equivalents developed-in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods of the exemplary embodiments. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing the exemplary embodiments. Those of ordinary skill in the art further understand that the exemplary hardware, software, processes, methods, and/or operating systems described herein are for illustrative purposes and, thus, are not intended to be limited to any particular named manufacturer.

The exemplary embodiments describe methods, systems, and devices that provide Simultaneous Ring Control services to different communications devices and difference communications networks. In some of the exemplary embodiments, a calling party uses a communications device that includes a computer program product—a Simultaneous Ring Control Module—that overrides a simultaneous ring service to multiple associated communications addresses. That is, the calling party can control routing of his/her outgoing communication signal to one or more selected communications address(es) associated with the simultaneous ring service and disable routing of his/her outgoing communication signal to other, non-selected communications address of the simultaneous ring service. For example, the calling party may wish to only contact a called party at a residential telephone number and not to disturb them at other communications addresses like an office telephone number, a cellular telephone number, and others. If the calling party knows that the called party subscribes to a simultaneous ring service that simultaneously tries to establish a communications connection with the first answering communications address of multiple communications address, then the calling party may control routing of his/her outgoing communication such that only the residential telephone number receives the communications signal and such that simultaneous ring services for other communications addresses (e.g., cellular phone, work phone, home computer, and others) are disabled. In further exemplary embodiments, a communications device of the called party having the Simultaneous Ring Control Module may further enable the called party to control an alternate message or alert to the disabled communications addresses such that the disabled communications address(es) receives a shared notification of the outgoing communication from the calling party and information of the communications connection among the calling party's communications device and the selected communications device of the called party. According to some of the exemplary embodiments, the calling party may use a conventional telephone to access a communications network having a server-component Simultaneous Ring Control Module, activate control features for communicating with one or more selected communications addresses of a simultaneous ring service, provide communications instructions each selected communications address, and communicate the communications signal to the selected communications address(es). The communications signal may include text, video, voice, and/or digital data.

The communications signal may be associated with multiple communications devices of the selected communications address, such as a POTS phone and a computer coupled with a modem communicating with a telecommunications network from the same switch (e.g., Service Node). After the communications signal is communicated to the selected called party's communications address(es), a connected communications device of the called party, or alternative a computer product of the communications network, may act on this information. For example, the called party may review a simultaneous ring instruction to select communication to selected communications address, forward the communications signal to any other communications address, store the communications signal (and/or simultaneous ring instructions) of the calling party's, ignore the communications signal, and/or other handling options. For example, the answering communications device may include a Simultaneous Ring Control Module that enables the called party to determine that simultaneous ring was disabled for other associated simultaneous ring communications addresses. Thereafter, the called party may interact with the Simultaneous Ring Control Module (or alternatively, the Simultaneous Ring Control Module may automatically generate) to generate a shared notification message to other associated simultaneous ring communications address, store the selection instructions from the calling party, and/or other handling options. For example, the called party may configure the software product to automatically communicate the answering communications address, the answering communications device, an identifier of the answering called party (e.g., the called party's name and general location, such as, for example, “John Johnson Home”, a different communications address for a future communication to the called party, and others), the communications address of the calling party, the communications device of the calling party, and an identifier of the calling party. Further, the Simultaneous Ring Control Module may further associate multiple communications addresses and/or multiple communications devices (e.g., POTS phone, cellular phone, personal digital assistant, VOIP phone, etc.) used by the subscriber (also referred to as the “called party” or the “user”). And, the Simultaneous Ring Control Module automates configuration and communication of the communications signal to the selected communications address(es) and/or the shared notification signal to associated, non-selected communications addresses of the simultaneous ring service. Additionally, a telecommunications customer may subscribe to a blocking service to decline or otherwise prevent a calling party from controlling simultaneous ring services to his/her associated communications addresses. Still further, if the called party blocks communication of the communications signal with simultaneous ring override instructions (e.g., instructions to only communicate the communications signal to selected communications addresses), then the server-component software residing on the communications network(s), may communicate a message (e.g., communications failure of the communications signal) to the selected communications address(es).

As used herein, the term “communications device” includes wired and wireless communications devices, such as a mobile phone, a wireless phone, a WAP phone, a satellite phone, a computer, a modem, a pager, a digital music device, a digital recording device, a personal digital assistant, an interactive television, a digital signal processor, and a Global Positioning System device. The communications device may include any computer, peripheral device, camera, modem, storage device, telephone, personal digital assistant, and/or mobile phone. The communications network may include coaxial cables, copper wires, fiber optic lines, and/or hybrid-coaxial lines. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may even include wireless portions utilizing any portion of the electromagnetic spectrum and any signaling standard (such as the I.E.E.E. 802 family of standards).

Further, as used herein, the term “data” includes electronic information, such as, for example facsimile, electronic mail (e-mail), text, video, audio, and/or voice in a variety of formats, such as dual tone multi-frequency, digital, analog, and/or others. Additionally, the data may include: (1) executable programs, such as a software application, (2) an address, location, and/or other identifier of the storage location for the data, (3) integrated or otherwise combined files, such as a grouping of destination communications addresses associated with the calling party, and/or (4) profiles associated with the communications signal and/or simultaneous ring instructions, including configuration, authenticity, security, and others. Still further, the term “processing,” as used herein, encompasses every event from the time the calling party communications device goes off-hook to the termination of the communications signal (e.g., hanging up the telephone call). “Processing” of the communications signal includes routing a voice path and signaling setup and intelligence (e.g., Local Number Portability queries, queries to retrieve Calling Name/Number information, intelligence queries by the AIN components, and standard signaling messages to determine communications routing paths). The term “processing” also includes monitoring an established communications link for possible entry of a simultaneous ring instruction of a communications signal, switch hook flash, other events that indicate a party on the telephone call has requested routing instructions to a selected communications address of the simultaneous ring service. Finally, in various embodiments, the data (e.g., communications signal and/or simultaneous ring instructions) may be stored by the communications network, a peripheral storage device connected to the communications network, the communications device of the calling party, one or more of the communications devices of the called party, and/or other connected networks.

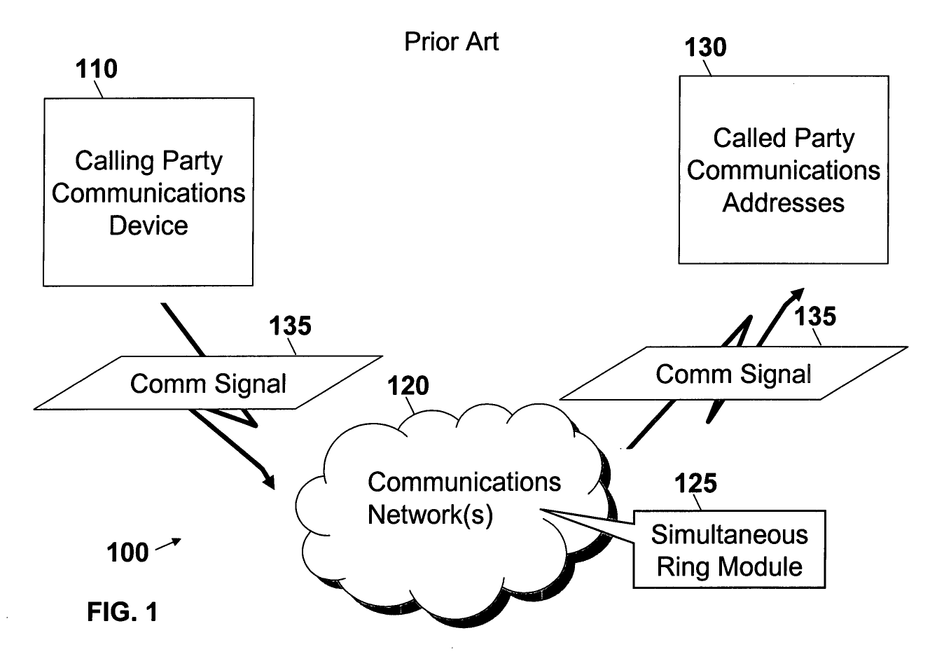

Referring now to the figures, FIG. 1 illustrates a schematic of a Simultaneous Ring communications system 100 as known by one of ordinary skill in the art. The communications system 100 includes at least one calling party's communications device 110 communicating a communications signal 135 to a simultaneous ring service line, at least one communications network 120 having a server-component of a Simultaneous Ring Module 125 to control simultaneous or round-robin routing of the communications signal to multiple communications addresses of the simultaneous ring service, and a plurality of called party's communications devices of the multiple communications addresses 130. In general, a calling party uses his/her communications device 110 to enter or otherwise input the simultaneous ring communications address and outgoing communications signal 135 (referred to as “Comm Signal” in FIG. 1) and initiate an incoming communications signal 135 to a plurality of called party's communications devices 130. The communications network(s) detects and decodes the communications signal with the simultaneous ring communications address 135, associates a plurality of communications addresses subscribing to a simultaneous ring service, and simultaneously (or, alternatively, round-robin) communicates the communications signal 135 to each called party's communications device associated with the plurality of communications addresses 130.

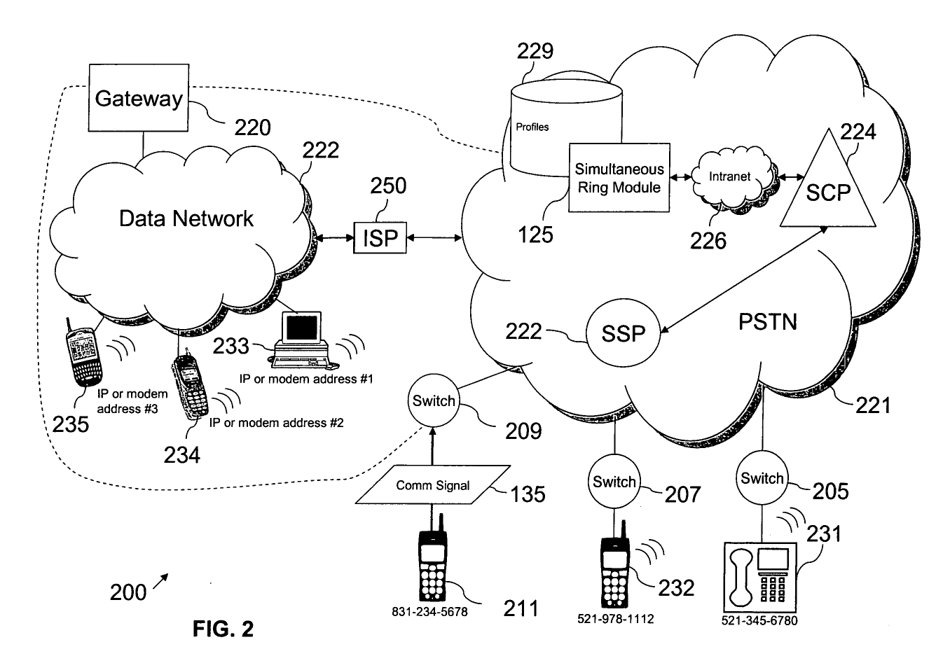

FIG. 2 illustrates a more detailed schematic of a Simultaneous Ring communications system 200 similar to communications system of FIG. 1. The Simultaneous Ring Communications system 200 depicts communications connections among at least two communications network(s) 221, 222, the calling party's communications device 211 having a communications address of 831-234-5678, and a plurality of called party's communications devices at various communications addresses—shown as POTS phone 231 having a communications address of 571-345-6780, cellular phone 232 having a communications address of 571-978-1112, computer system 233 having a first IP or modem communications address, a VoIP phone 234 having a second IP or modem communications address, and a PDA 235 having a third IP or modem communications address. The POTS phone 231 is coupled with a communications switch 205 connected to a telecommunications network 221. The cellular phone 232 transmits and receives signals with a Mobile Switching Office (MSO) (not shown) that communicates with switch 207 to connect to the telecommunications network 221. The telecommunications network 221 includes a service switching point (SSP) 222, a service control point (SCP) 224, an Intranet 226 (for the telecommunications provider to administer and program the telecommunications network 221 components), a Simultaneous Ring Dataserver having the Simultaneous Ring Module 125, and a database of one or more Simultaneous Ring profiles 229. The system 200 further includes an Internet Service Provider (e.g., America On-Line) 250, a data network 222 communicating with communications devices 233, 234, and 235, a gateway 270, and a third communications switch 209 connected to the calling party's communications device—shown as a cellular phone 211 (that is capable of communications with the telecommunications network 221 and with the data network 222). Each switch 205, 207, and 209 allows the connected communications device to transceive electronic communication signals via the data network 222 (e.g., world wide electronic data network such as an Internet, an Intranet, and/or an Extranet) and/or the telecommunications network 221 (e.g., a central office (CO), MSO, and/or a combination CO/MSO). The telecommunications network 221 may use any means of coupling one of the switches 205, 207, and 209 to the telecommunications network 221, but the coupling means is preferably high-capacity, high-bandwidth optical transport services, Gigabit Ethernet services, and/or the like. As those of ordinary skill in the art of telecommunications understand, the telecommunications network 221 could also link each of the switches 205, 207, and 209 via other appropriate means, such as, for example a Synchronous Optical Network (SONET) structure with redundant, multiple rings.

The calling party uses his/her communications device 211 to enter or otherwise input the simultaneous ring communications address to initiate a communications signal 135 to a called party having a plurality of communications addresses associated with the simultaneous ring service. The called party of the simultaneous ring service is alerted of the incoming communication at each of the associated called party's communications devices 231, 232, 233, 234, and 235 to gain access to the telecommunications network 221 and/or to the data network 222. For example, the communications signal from the calling party's communications device 211 is routed through the telecommunications network 221 via switch 205. Alternatively, the communications signal from the calling party's communications device 211 may be routed through switch 209 to the gateway 270 for further communication and/or processing with the data network 222 and/or the telecommunications network 221. The communications signal along with the communications signal 135 is detected at SSP 222 and decoded by the SCP 224 and by the Simultaneous Ring Module 125 of the communications network 221 to associate each communications address of the simultaneous ring service lines to called party's communications device 231, 232, 233, 234, and/or 235. That is, a simultaneous ring service to a plurality of communications addresses is detected by the SSP 222, then the SCP 224 and the Simultaneous Ring DataServer having the Simultaneous Ring Module further processes and routes the communications signal 135 simultaneous or in a round-robin fashion to each of the plurality of communications addresses.

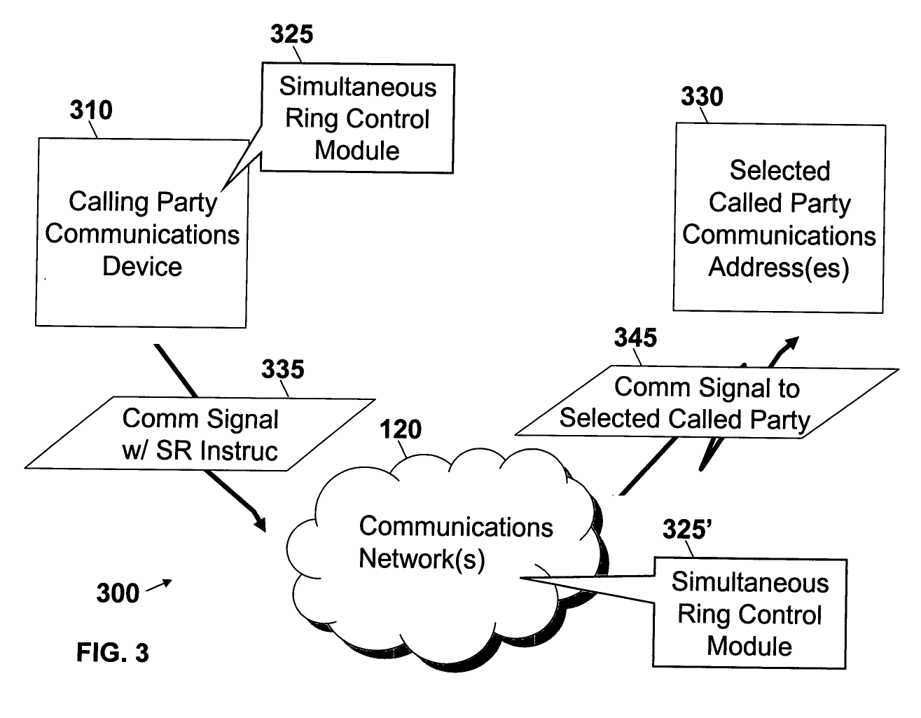

Referring now to FIG. 3, a Caller Simultaneous Ring Control communications system 300 illustrates a schematic of a Simultaneous Ring communications system 300. The communications system 100 includes at least one calling party's communications device 110 having a Simultaneous Ring Control Module 325 that communicates communications signal with simultaneous ring instructions 335, at least one communications network 120 having a server-component of a Simultaneous Ring Control Module 325′ to control simultaneous or round-robin routing of the communications signal to the selected called party communications address 345 to one or more calling party selected communications addresses of the called party 330. In general, a calling party uses his/her communications device 310 to access a user interface of the Simultaneous Ring Control Module 325 and input selective routing instructions for communicating with a particular communications address and/or a particular communications device associated with a simultaneous ring service. For example, if the calling party is calling a telephone number that he/she knows will simultaneously ring or round-robin ring at multiple locations—the called party's home, the called party's work, a relative's home, a remote location, and other locations—or at different communications devices—cellular phone, PDA, VoIP phone —of the called party, then the calling party may enter or otherwise input instructions to override the configuration of the called party's simultaneous ring service and select one particular phone number to ring (e.g., only ring the called party's home telephone) and consequently disable simultaneous ring to the other locations and/or other devices (e.g., disable the incoming communication to the called party's home computer).

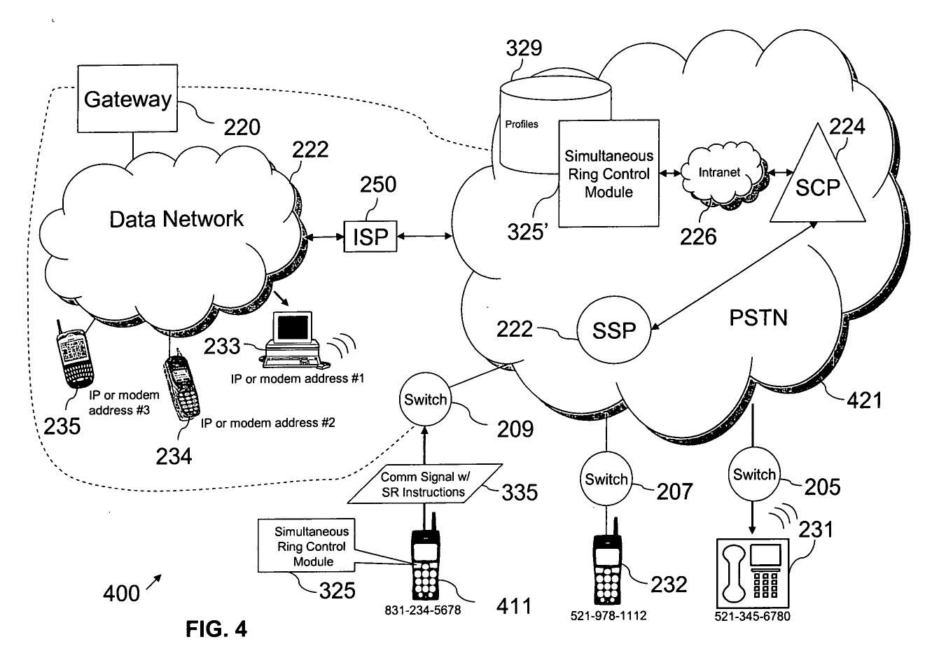

FIG. 4 illustrates a more detailed schematic of a Caller Simultaneous Ring Control communications system 400 similar to the communications system 300 of FIG. 3. The Caller Simultaneous Ring Control communications system 400 depicts the communications connections among at least two communications network(s) 421, 222, the calling party's communications device 211 having a communications address of 831-234-5678 and having the Simultaneous Ring Control Module 325, and the plurality of called party's communications devices at various communications addresses—shown as POTS phone 231 having a communications address of 571-345-6780, cellular phone 232 having a communications address of 571-978-1112, computer system 233 having a first IP or modem communications address, a VoIP phone 234 having a second IP or modem communications address, and a PDA 235 having a third IP or modem communications address. Similar to communications system 200, the POTS phone 231 is coupled with a communications switch 205 connected to a telecommunications network 421. The cellular phone 232 transmits and receives signals with a Mobile Switching Office (MSO) (not shown) that communicates with switch 207 to connect to the telecommunications network 421. The telecommunications network 421 includes a service switching point (SSP) 222, a service control point (SCP) 224, an Intranet 226 (for the telecommunications provider to administer and program the telecommunications network 421 components), a Simultaneous Ring Dataserver having a Simultaneous Ring Control Module 325′, and a database of one or more Simultaneous Ring Control profiles 229. The system 200 further includes the Internet Service Provider (e.g., America On-Line) 250, the data network 222 communicating with communications devices 233, 234, and 235, the gateway 270, and the third communications switch 209 connected to the calling party's communications device—shown as a cellular phone 211 (that is capable of communications with the telecommunications network 421 and with the data network 222).

The calling party uses his/her communications device 211 to enter or otherwise input a selected simultaneous ring communications address or other simultaneous ring instruction(s) to initiate a simultaneous ring override communications signal 335 to a called party having a plurality of communications addresses associated with the simultaneous ring service. The communications network 222 or 421 detects and decodes the simultaneous ring override communications signal 335, and only communicates the communications signal to the selected called party 345 to the selected called party's communications addresses 231 and 233 of the simultaneous ring service. That is, the communications network 222 or 421 does not communicate the communications signal to the selected called party 345 to other associated simultaneous ring communications addresses 232, 234, and 235. For example, the simultaneous ring override communications signal 335 may be routed through the telecommunications network 421 via switch 205. Alternatively, the simultaneous ring override communications signal 335 may be routed through switch 209 to the gateway 270 for further communication and/or processing with the data network 222 and/or the telecommunications network 421. The simultaneous ring override communications signal 335 is detected at SSP 222 and decoded by the SCP 224 and by the Simultaneous Ring Control Module 325 of the telecommunications network 421 to access a Simultaneous Ring Control Profile that (1) associates each communications address of the simultaneous ring service line to the called party's communications addresses 231, 232, 233, 234, and/or 235, (2) includes instructions to disable simultaneous ring services to some of the called party's communications addresses 232, 234, and 235, (3) includes instructions to only communicate the communications signal to the selected called party 345 to the selected communications addresses of the called party 231, 233, (4) includes instructions to otherwise enable calling party control of the simultaneous ring service (e.g., password on pin code requirement, only enable for calling party's at a communications address selected by the called party, and others), (5) includes instructions to block calling party controls of the subscriber's simultaneous ring service, (6) includes instructions to generate an alternate alert to the communications address having disabled simultaneous ring service, and/or (7) includes instructions to otherwise manage simultaneous ring controlled features. Consequently, in the communications system 400, the caller controlled communications signal 335 to simultaneous ring service (or simultaneous ring communications address or service line) is detected by the SSP 222, then the SCP 224 and the Simultaneous Ring DataServer having the Simultaneous Ring Control Module 325 further processes and only routes the communications signal to the selected called party 345 simultaneous or in a round-robin fashion to the selected communications addresses 231 and 233.

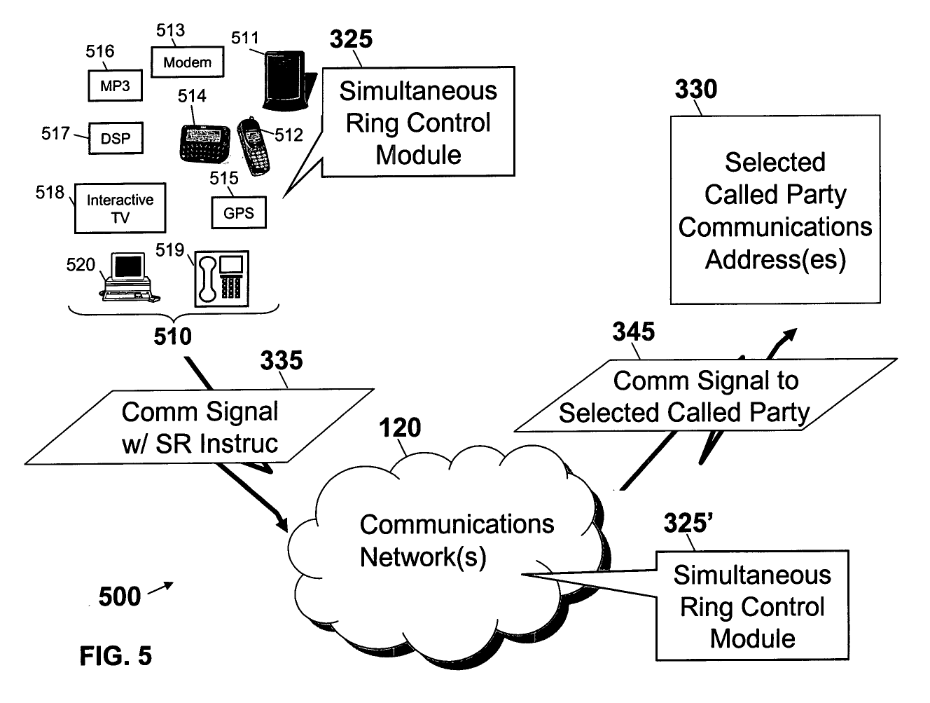

FIG. 5 illustrates a Caller Simultaneous Ring Control communications system 500 similar the Caller Simultaneous Ring Control communications system 300 of FIG. 3; however, the Caller Simultaneous Ring Control communications system 500 illustrates various types of communications devices 510 that may be used by the calling party to initiate the simultaneous ring override communications signal 335 to the called party having a plurality of communications addresses associated with the simultaneous ring service. Further, the Simultaneous Ring Control Module 325 and/or the server-component Simultaneous Ring Control Module125′ operates within any of these various types of communications devices 510 that include a personal digital assistant (PDA) 511, a Voice over Internet Protocol (VOIP) phone 512, a modem 513, an interactive pager 514, a Global Positioning System (GPS) device 515, a digital musical recorder device 516, any computer system utilizing a digital signal processor 517, an interactive television 518, a Plain Old Telephone System (POTS) phone 519, and/or a computer 520. The communications device 510 may also include watches, radios, vehicle electronics, clocks, printers, gateways, and other apparatuses and systems. As those of ordinary skill in the art understand, the communications device 510 and the Simultaneous Ring Control Module 325 (or, alternatively, the communications device 510 and the Simultaneous Ring Control Module 325′ of the communications network 120) has the intelligence for appropriate communicating with the selected communications device of the called party 330. For example, if the communications device 510 uses the Wireless Application Protocol (WAP) technique, then the simultaneous ring override communications signal 335 is formatted using the Wireless Mark-up Language (WML) and configured according to standards known in the art. The Wireless Mark-up Language (WML) and the WAP technique are known and will not be further described. This is a description of a solution for a specific wireless protocol, such as WAP. This solution may be clearly extended to other wireless protocol, such as i-mode, VoiceXML (Voice eXtensible Markup Language), Dual Tone Multi-Frequency (DTMF), and other signaling means.

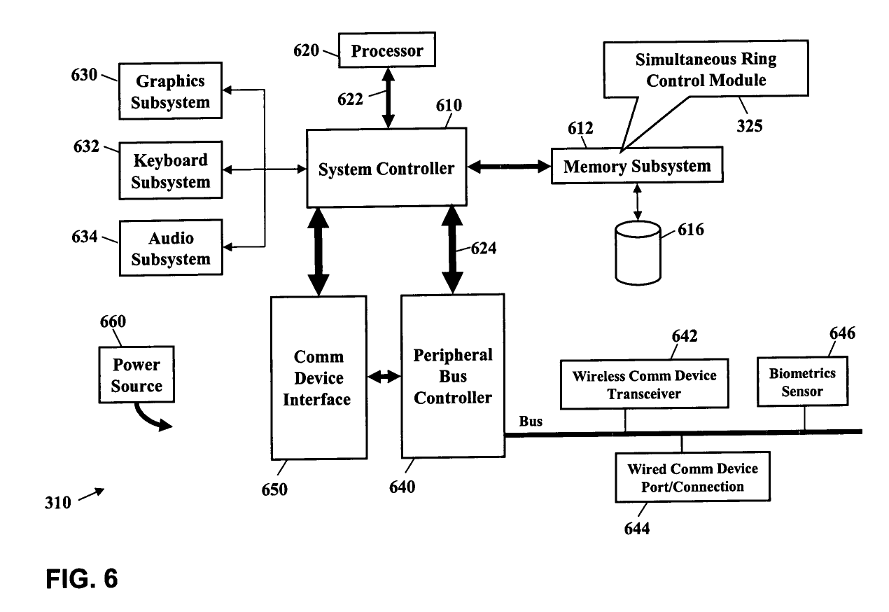

FIG. 6 is a block diagram of exemplary details of the communications device 310 shown in FIG. 2. The communications device 310 includes the Simultaneous Ring Control Module 325 that operates within a system memory device 612. The Simultaneous Ring Control Module 325, however, could also reside in flash memory or a peripheral storage device 616. The communications device 310 also has one or more central processors 620 executing an operating system. The operating system, as is well known, has a set of instructions that control the internal functions of the communications device 310. A system bus 622 communicates signals, such as data signals, control signals, and address signals, between the central processor(s) 620 and a system controller 610. The system controller 610 provides a bridging function between the memory subsystem 612, the one or more central processors 620, a graphics subsystem 630, a keyboard subsystem 632, an audio subsystem 634, a PCI (Peripheral Controller Interface) bus 624, and a Communications (“Comm”) Device Interface 650. The PCI bus 624 is controlled by a Peripheral Bus Controller 640. The Peripheral Bus Controller 640 is an integrated circuit that serves as an input/output hub for various peripheral ports and/or transceivers. These peripheral ports allow the communications device 310 to communicate with a variety of communications devices through networking ports (such as SCSI or Ethernet) that include Wireless Communications (“Comm”) Device Transceiver 642 (such as Wireless 802.11 and Infrared) and Wired Communications (“Comm”) Device Port/Connection 644 (such as modem V90+and compact flash slots). These peripheral ports could also include other networking ports, such as, a serial port (not shown) and/or a parallel port (not shown). The Comm Device Interface 650 allows the communications device 310 to monitor, detect, receive, and decode incoming communications signals to the communications device(s) connected to the Wireless Comm Device Transceiver 642 and/or the Wired Comm Device Port/Connection 646. Further, the Comm Device Interface 650 transmits the outgoing communications signal and/or simultaneous ring instructions 335 to the Wireless Comm Device Transceiver 642 and/or the Wired Comm Device Port/Connection 646. Still further, the communications device 310 may include a power source 660, such as a rechargeable battery to provide power and allow the communications device 310 to be portable. In alternate embodiments, the communications device 310 could include its own telephone line (or other communications connection) to the communications network 120 (not shown). Another alternative may include the communications device 310 incorporated into a specially designed communications device (not shown). Those of ordinary skill in the art understand that the program, processes, methods, and systems described herein are not limited to any particular architecture or hardware.

The processors 620 may be implemented with a digital signal processor (DSP) and/or a microprocessor. Advanced Micro Devices, Inc., for example, manufactures a full line of microprocessors (Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Texas Instruments offers a wide variety of digital signal processors (Texas Instruments, Incorporated, P.O. Box 660199, Dallas, Tex. 75266-0199, Phone: 972-995-2011, www.ti.com) as well as Motorola (Motorola, Incorporated, 1303 E. Algonquin Road, Schaumburg, Ill. 60196, Phone 847-576-5000, www.motorola.com). There are, in fact, many manufacturers and designers of digital signal processors, microprocessors, controllers, and other components that are described in this patent. Those of ordinary skill in the art understand that this components may be implemented using any suitable design, architecture, and manufacture. Those of ordinary skill in the art, then understand that the exemplary embodiments are not limited to any particular manufacturer's component, or architecture, or manufacture.

The system memory device (shown as memory subsystem 612 or peripheral storage device 616) may also contain one or more application programs. For example, an application program may cooperate with the operating system and with a video display unit (via graphics subsystem 630) to provide a GUI for the Simultaneous Ring Control Module 325. The GUI typically includes a combination of signals communicating with the graphics subsystem 630 and/or the keyboard subsystem 632. The GUI provides a convenient visual and/or audible interface with the user of the communications device 310. As is apparent to those of ordinary skill in the art, the user (e.g., calling party) interacts with the Simultaneous Ring Control Module over a variety of mediums, such as, for example, a stylus, keyboard, and punch buttons of the keyboard subsystem 632, a display screen of the graphics subsystem 630, and/or a voice-activated menu prompt of the audio subsystem 634. Additionally, the peripheral bus controller 640 provides an interface with a biometrics sensor 646, such as, for example, a fingerprint ID device. The biometrics sensor 646 may distinguish between different users that share or otherwise use the communications device 310. Further, the biometrics sensor 646 may provide security features that prevent unauthorized users from exploiting the communications device 310. The biometrics sensor 646 could also comprise retina recognition device and software, DNA/RNA recognition device and software, facial recognition device and software, speech recognition device and software, and/or scent recognition device and software.

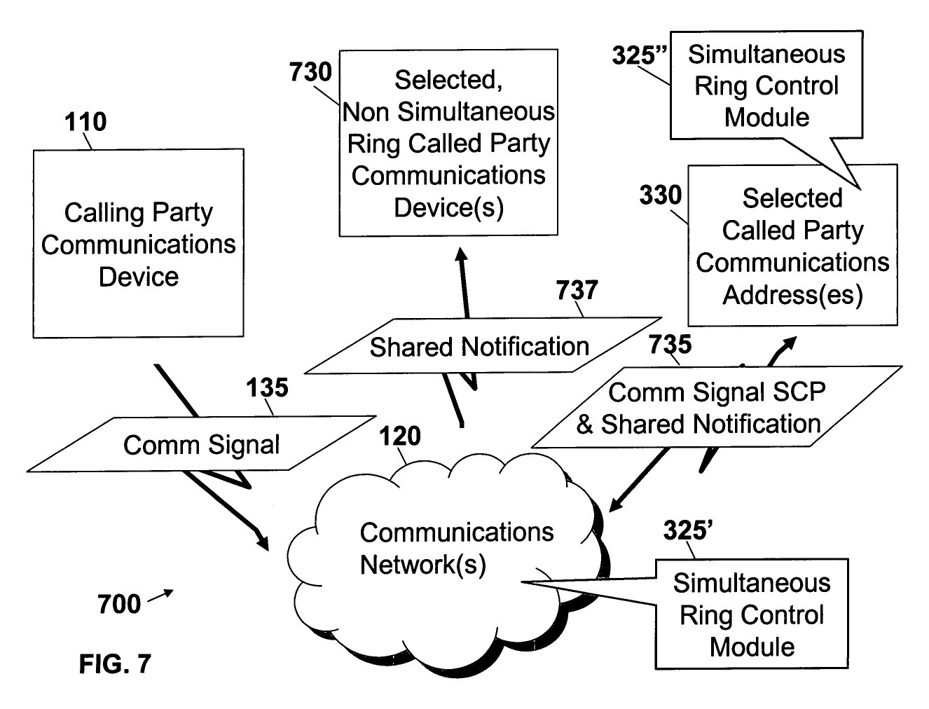

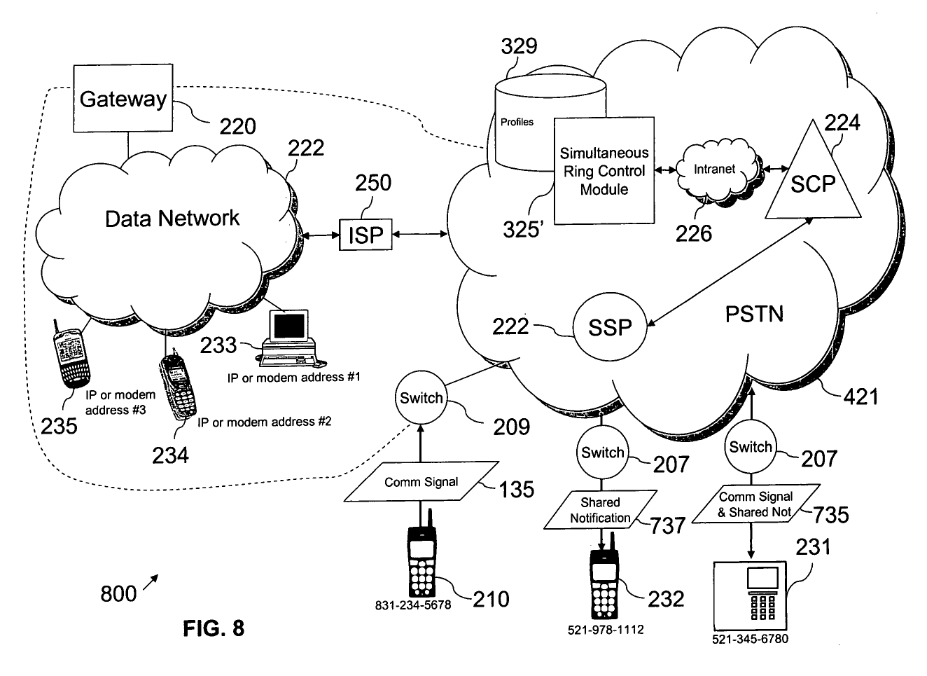

FIG. 7 illustrates a Caller Simultaneous Ring Control Notification communications system 700 similar to communications system 300 of FIG. 3; however communications system 700 further includes the communications signal and a shared notification 735 communicated among the selected called party's communications address(es) to the communications network 120 and a shared notification 737 from the communications network 737 to a disabled simultaneous ring communications address 730. The called party may establish preferences in the Simultaneous Ring Control profile for selecting disabled communications addresses to notify. For example, FIG. 8 illustrates a Caller Simultaneous Ring Control communications system 800 similar the Caller Simultaneous Ring Control communications system 400 of FIG. 4; however, the Caller Simultaneous Ring Control communications system 800 further includes a communications signal and a shared notification that is communicated with only the selected called party's communications address 735 and a shared notification communications signal 737 that is communicated to another selected communications address of the simultaneous ring service. As shown in FIG. 8, the calling party initiates a communications signal 135 to a simultaneous ring service line that is associated with communications addresses 231, 232, 233, 234, and 235. The Simultaneous Ring Control Module 325′ of the communications network detects the incoming communication, identifies the associate communications addresses of the called party, and accesses a Simultaneous Ring Control profile that includes instructions to only route the communications signal to the selected called party and shared notification 735 with the POTs phone 231, to generate the shared notification message 737, and to initiate or otherwise establishes a communications connection with another communications address 732 of the simultaneous ring service to communicate the shared notification message 737 such that the cellular phone of communications address 732 presents a message of the limited delivery of the communications signal to the selected called party communications address 231. For example, if a doctor's office called a simultaneous ring service line that only routed the call to POTS phone 231, then the subscriber or user may establish the profile such that all communications from the doctor's office are also reported to the called party's cell phone 732. Consequently, the called party is also able to control activation, management, and communications to each communications address of the simultaneous ring service.

The Simultaneous Ring Control Module 325, 325′, and 325″ may reside on the calling party's communications device, a server-component of the communications network, and/or the called party's communications devices. Further, the telecommunications network 421 may include wired, optical, and/or wireless elements and may further include private network elements, such as private branch exchanges (PBXs), and/or other elements (not shown). The telecommunications network 421 includes Advanced Intelligent Network (AIN) componentry controlling many features of the network. The telecommunications network 221, 421 and/or each of the switches 205, 207, and 209 could also include a packet-based “soft switch” that uses software control to provide voice, video, and/or data services by dynamically changing its connection data rates and protocols types. If the telecommunications network 421 and/or one of the switches 205, 207, and 209 should include a softswitch, the AIN componentry is replaced by an application server that interfaces with the softswitch via a packet protocol, such as Session Initiation Protocol (SIP). The means of communicating the communications signal, simultaneous ring override instructions, and/or a shared notification signal between or among the selected called party's communications device 231, the switch 205, the telecommunications network 421 including AIN componentry and the Simultaneous Ring Control Module 325′, the data network 222 including the gateway 270, and the calling party's communications device 411 include a variety of means, including optical transmission of data (e.g., any medium capable of optically transmitting the data), wireless transmission of data (e.g., wireless communications of the data using any portion of the electromagnetic spectrum), and/or fixed-wire transmission of data (e.g., any medium capable of transmitting electrons along a conductor). Fiber optic technologies, spectrum multiplexing (such as Dense Wave Division Multiplexing), Ethernet and Gigabit Ethernet services, Infrared, the family of IEEE 802 standards, and Digital Subscriber Lines (DSL) are just some examples of the transmission means. The signaling between the called party's communications device 231, 232, 233, 234, and/or 235, the switches 205, 207, and 209, the telecommunications network 421 including AIN componentry, the data network 222 including the gateway 270, and the calling party's communications device 411, however, are well understood in by those of ordinary skill the art and will not be further described. Further, those of ordinary skill in the art will be able to apply the principles of this invention to their own network configurations which may differ substantially from the communications system(s) shown in the figures.

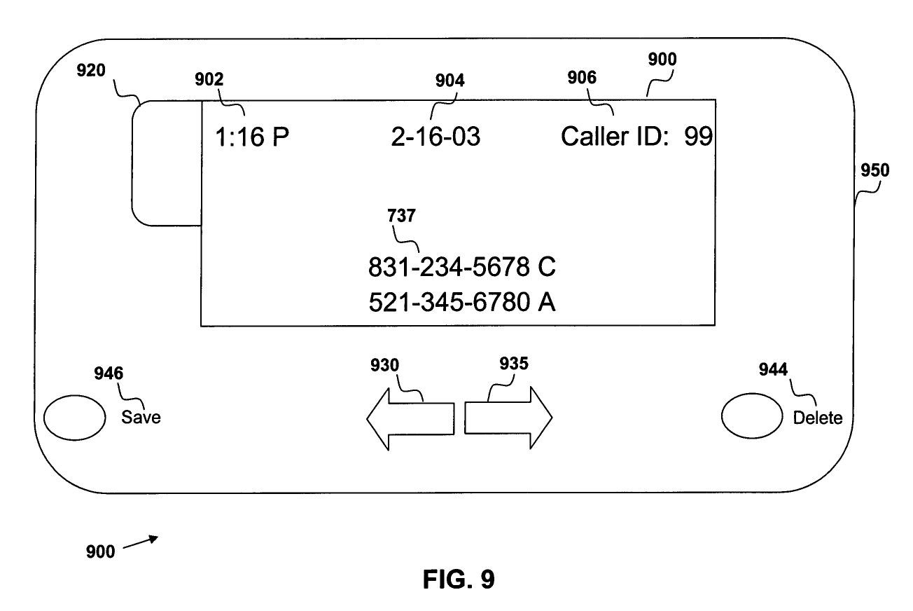

FIG. 9 illustrates a schematic of a conventional CallerID device 900 that may be coupled with a disabled simultaneous ring communications device, such as reference numeral 732 shown in FIG. 8. The CallerID device 900 includes a display screen 900 having a time identifier 902, a date identifier 904, a numeric identifier 906 of an incoming CallerID signal, a lighted panel 920 that alerts the calling party of a new, incoming, and/or stored ICLID signal, a “Save” punch button 946, a “Delete” punch button, a left arrow button 930, a right arrow button 935, and a housing 950 that protects the internal componentry of the CallerID device 900. Typically, the CallerID device 900 receives an incoming ICLID signal and displays an originating NANP number (i.e., the telephone number of a calling party for an incoming call) and/or a name associated with the originating NANP number to display 945. Conventional CallerID devices comply with standards known in the art that limit the display of the ICLID signal to two lines of text, each line containing approximately fifteen (15) characters. As shown in FIG. 9, when the CallerID device 900 receives the shared notification 737, a display presents the calling party's communications device shown as “831-234-5678 C” with the “C” indicating the caller identification of the calling party and also presents the selected called party's communications device shown as “521-345-6780 A” with the “A” indicating a selected communications address that is answered by the called party. Other status identifiers and notifications may be used, including, text, audio, video, and doodles. Further, the CallerID device 900 of FIG. 9 stores the selected simultaneous ring, called party communications address and the calling party's communications address.

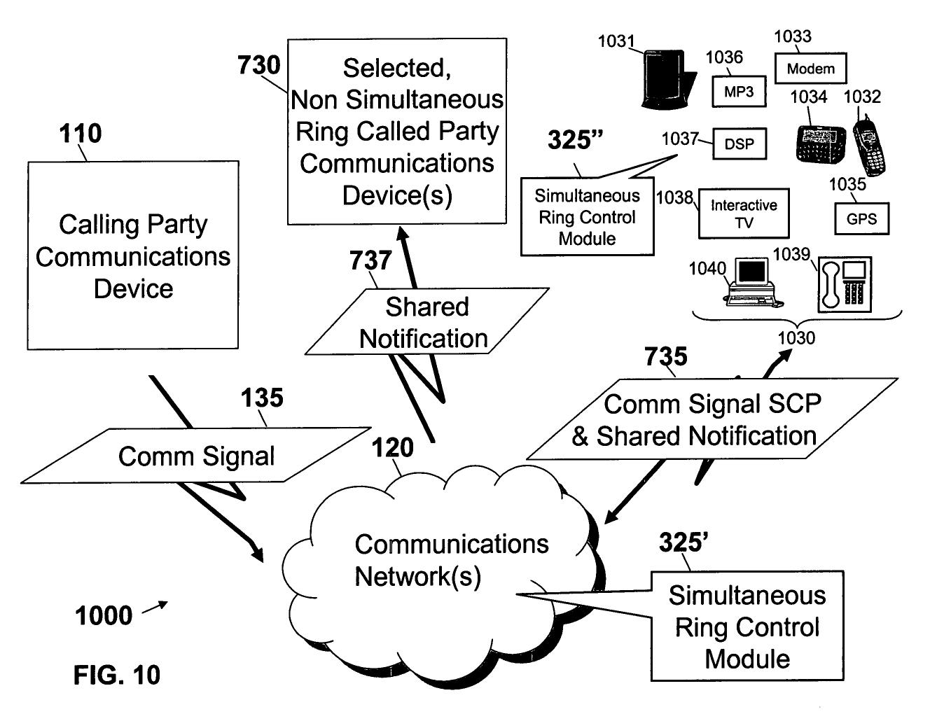

FIG. 10 is a schematic of a Caller Simultaneous Ring Control Notification communications system 1000 similar to communications system 700 of FIG. 7; however communications system 1000 further includes various types of communications devices 1030 that may be used by the called party to communicate the shared notifications 737 to selected, disabled simultaneous ring communications addresses 730 via the communications network 120. Further, the Simultaneous Ring Control Module 325″ and/or the server-component Simultaneous 1030 that include a personal digital assistant (PDA) 1031, a Voice over Internet Protocol (VOIP) phone 1032, a modem 1033, an interactive pager 1034, a Global Positioning System (GPS) device 1035, a digital musical recorder device 1036, any computer system utilizing a digital signal processor 1037, an interactive television 1038, a Plain Old Telephone System (POTS) phone 1039, and/or a computer 1040. The communications device 1030 may also include watches, radios, vehicle electronics, clocks, printers, gateways, and other apparatuses and systems. As those of ordinary skill in the art understand, the communications device 1030 and the Simultaneous Ring Control Module 325 (or, alternatively, the communications device 1030 and the Simultaneous Ring Control Module 325′ of the communications network 120) has the intelligence for appropriate communicating with the selected, disabled simultaneous ring communications device 730. For example, if the communications device 1030 uses the Wireless Application Protocol (WAP) technique, then the shared notification signal 737 is formatted using the Wireless Mark-up Language (WML) and configured according to standards known in the art. The Wireless Mark-up Language (WML) and the WAP technique are known and will not be further described. This is a description of a solution for a specific wireless protocol, such as WAP. This solution may be clearly extended to other wireless protocol, such as i-mode, VoiceXML (Voice eXtensible Markup Language), Dual Tone Multi-Frequency (DTMF), and other signaling means. Alternatively, the shared notification signal 737 may be formatted and/or otherwise configured for presentation by an application and/or componentry of the disabled, simultaneous ring communications device 730.

The simultaneous ring control application (shown as reference numerals 325, 325′, and 325″ in FIGS. 3-5, 7-8, and 10) may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the embodiments, allow the Simultaneous Ring Control application to be easily disseminated.

The simultaneous ring control application may also be physically embodied on or in any addressable (e.g., HTTP, I.E.E.E. 802.11, Wireless Application Protocol (WAP)) wire line or wireless device capable of presenting an IP address. Examples could include a computer, a wireless personal digital assistant (PDA), an Internet Protocol mobile phone, or a wireless pager.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method for ring control, comprising:
detecting and decoding an outgoing communication signal from a communications address of a calling party's communications device to a selected simultaneous ring communications address of a called party, the selected simultaneous ring communications address comprising one of a plurality of different communications addresses associated with a simultaneous ring service such that the simultaneous ring service is disabled for a non-selected communications address; and
communicating the outgoing communications signal to the selected simultaneous ring communications address.

2. The method of claim 1, further comprising:
establishing a communications connection of the selected simultaneous ring communications address of an answering communications address with the calling party's communications address.

3. The method of claim 1, wherein the step of detecting and decoding the outgoing communications signal from a communications address of a calling party's communications device to a selected simultaneous ring communications address of a called party comprises associating a simultaneous ring control profile comprising (i) the plurality of different communications addresses, (2) an instruction to disable simultaneous ring service to one or more of the plurality of different communications addresses, (3) an instruction to only communicate the communications signal to a selected communications device of the plurality of different communications addresses, (4) an instruction to enable calling party control of the simultaneous ring service, (5) an instruction to block calling party control of the simultaneous ring service, (6) an instruction to generate an alternate alert to a communications address having disabled simultaneous ring service, and (7) an instruction to manage simultaneous ring control features.

4. The method of claim 3, further comprising:
communicating the alternate alert to the non-selected communications address having disabled simultaneous ring service.

5. The method of claim 4, further comprising:
presenting the alternate alert to a communications device of the non-selected communications address having disabled simultaneous ring service.

6. A communications system, comprising:
a simultaneous ring control application for detecting and decoding an outgoing communication signal from a communications address of a calling party communications device to a selected simultaneous ring communications address of a called party, the selected simultaneous ring communications address comprising one of a plurality of different communications addresses associated with a simultaneous ring service, the simultaneous ring control application further for generating a communications signal to the selected called party such that the simultaneous ring service is disabled for non-selected simultaneous ring communications addresses.

7. The communications system of claim 6, further comprising:
a communications connection over a communications network, the communications link allowing the calling party communications device and an answering, selected called party communications device of a simultaneous ring service line to transmit and receive communications signals;
a database of at least one simultaneous ring control profile, the simultaneous ring control profile comprising (i) a plurality of different communications addresses associated with a simultaneous ring service, (2) an instruction to disable simultaneous ring service to one or more of the plurality of different communications addresses, (3) an instruction to only communicate the communications signals to a selected communications device of the plurality of different communications addresses, (4) an instruction to enable calling party control of the simultaneous ring service, (5) an instruction to block calling party control of the simultaneous ring service, (6) an instruction to generate an alternate alert to a communications address having disabled simultaneous ring service, and (7) an instruction to manage simultaneous ring control features,
a processor, the processor operating with the simultaneous ring control application and the database for accessing, processing, and managing the communications signal communicated among the calling party communications device and the selected simultaneous ring communications address, and
a communications interface for communicating the communications signal over the communications network to the selected simultaneous ring communications address.

8. The system of claim 7, the communications network comprising a public switched telephone network, a mobile switching telephone communications network, and a satellite network.

9. The system of claim 7, the communications network simultaneously communicating a communications signal to establish a voice connection between the calling party communications device and the selected simultaneous ring communications device.

10. The system of claim 7, the calling party communications device comprising:
a POTS phone,
a wireless communications device,
a mobile phone,
a wireless phone,
a WAP phone,
a satellite phone
a computer,
a modem,
a pager,
a digital music device,
a digital recording device,
a personal digital assistant,
an interactive television,
a digital signal processor, and
a Global Positioning System device.

11. The system of claim 7, the called party communications device comprising:
a caller identification device,
a POTS phone,
a wireless communications device,
a mobile phone,
a wireless phone,
a WAP phone,
a satellite phone
a computer,
a modem,
a pager,
a digital music device,
a digital recording device,
a personal digital assistant,
an interactive television,
a digital signal processor, and
a Global Positioning System device.

12. The system of claim 7, the communications network further comprising a world wide electronic data communications network.

13. The system of claim 6, the communications signal to the selected called party comprising text, voice, video, and electronic data.

14. The system of claim 7, the communications link comprises a voice connection and a data connection.

15. A computer program product, comprising instructions for:
detecting and decoding an outgoing communication signal from a communications address of a calling party's communications device to a selected simultaneous ring communications address of a called party, the selected simultaneous ring communications address comprising one of a plurality of different communications addresses associated with a simultaneous ring service such that the simultaneous ring service is disabled for a non-selected communications address; and
communicating the outgoing communications signal to the selected simultaneous ring communications address.

16. The computer program product of claim 15, further comprising instructions for:
establishing a communications connection of the selected simultaneous ring communications address of an answering communications address with the calling party's communications address.

17. The computer program product of claim 15, wherein the instruction for detecting and decoding the outgoing communications signal from a communications address of a calling party's communications device to a selected simultaneous ring communications address of a called party further comprises an instruction to associate a simultaneous ring control profile comprising (i) the plurality of different communications addresses, (2) an instruction to disable simultaneous ring service to one or more of the plurality of different communications addresses, (3) an instruction to only communicate the communications signal to a selected communications device of the plurality of different communications addresses, (4) an instruction to enable calling party control of the simultaneous ring service, (5) an instruction to block calling party control of the simultaneous ring service, (6) an instruction to generate an alternate alert to a communications address having disabled simultaneous ring service, and (7) an instruction to manage simultaneous ring control features.

18. The computer program product of claim 17, further comprising instructions for:
communicating the alternate alert to the non-selected communications address having disabled simultaneous ring service.

19. The computer program product of claim 18, further comprising instructions for:
presenting the alternate alert to a communications device of the non-selected communications address having disabled simultaneous ring service.
